(19) United States
(12) Patent Application Publication
(10) Pub. No.: US 2022/0122191 A1
(43) Pub. Date: Apr. 21, 2022

(54) AUTOMATED MATCHMAKING AND SOCIAL INTERACTION SYSTEMS AND METHODS

(71) Applicant: Rietta Boksha, Kailua, HI (US)

(72) Inventor: Rietta Boksha, Kailua, HI (US)

(21) Appl. No.: 17/075,543

(22) Filed: Oct. 20, 2020

(51) Int. Cl. G06Q 50/00; H04L 29/08

(52) U.S. Cl. CPC G06Q 50/01; H04L 67/306

(57) ABSTRACT

A social networking system receives an indication from a plurality of users to join a social match network. Each of the plurality of users provides information, including profile information. The social networking system creates a user profile associated with each user based on the information. The social networking system populates a directory with a user identifier associated with each user. The social networking system generates a list of matches for at least a subset of the plurality of users based on match preferences and the information provided by the user. The social networking system can receive an indication from the user to form a connection with a second user. The social networking system can receive an indication from the second user to accept the connection request. The social networking system can form the connection between the user and the second user based on the indications.

### TECHNICAL FIELD

This disclosure relates in general to automated matchmaking and social interaction.

### BACKGROUND

Online social networking and matchmaking services allow individuals and groups to contact and communicate with each other over the Internet. For example, an individual may use an online matchmaking service to meet new persons to develop new relationships. Online networking and matchmaking services generally attempt to facilitate these services over the Internet through the use of personal computers, tablet computers, cell/smart phones, and/or other network enabled computing devices.

### BRIEF DESCRIPTION OF THE DRAWINGS

FIG. 1 is a block diagram illustrating a social networking system for facilitating social networking, according to some embodiments.

FIG. 2 is a functional logic diagram for a social networking platform for facilitating matching, networking, and/or community building, according to some embodiments.

FIG. 3 is a functional logic diagram for a registration module for enabling users to access the social networking platform, according to some embodiments.

FIG. 4 is a functional logic diagram for a networking module of the social networking platform for facilitating matching users, according to some embodiments.

FIG. 5 is a functional logic diagram for a chat module of the social networking platform for enabling the user to communicate with another user, according to some embodiments.

FIG. 6 is a functional logic diagram for an event module of the social networking platform for managing events, according to some embodiments.

FIG. 7 is a functional logic diagram for a media sharing module of the social networking platform for facilitating matching of users, according to some embodiments.

FIG. 8 is a functional screen diagram for social networking within the system 100, according to some embodiments.

FIG. 9 is a functional screen diagram for social networking within the system 100, according to some embodiments.

FIG. 10 is a functional screen diagram for social networking within the system, according to some embodiments.

FIG. 11 is a functional screen diagram for social networking within the system, according to some embodiments.

FIG. 12 is a functional screen diagram for social networking within the social networking system, according to some embodiments.

FIG. 13 is a flow chart of an example of a method for using the social networking platform.

FIG. 14 is a flow chart of an example of a method for using the social networking platform.

FIG. 15 is a block diagram illustrating a processing system.

### DETAILED DESCRIPTION

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

### System Overview

A system and method are described for online social networking. The present technology provides a social networking system that enables a user to participate in a social network to form connections, meet new users, share media files and resources (e.g., pictures, videos, and documents), or create, view, and/or register to events. The social networking system enables the user to provide personal information about themselves. The user can search a directory of users for other users using various criteria, such as age range, gender, interests, work experience, and location.

Some embodiments of the social network facilitate forming connections between mentors and mentees through a matching program. The social network can include mentors, mentees, and general members. The social networking system can automatically identify mentor(s) and/or mentee(s) for users of the system. Recommended mentor/mentee pairings can be generated at least in part based on user profiles of the respective users. Furthermore, the mentor/mentee relationships facilitated by the social networking system may have any specific or general purpose. For example, some mentor/mentee relationships may be formed around a general topic, such as navigating civilian life after leaving the military, while others are formed around specific topics such as enrolling in health insurance. Some embodiments of the social networking system automatically identify recommended mentor(s) or mentee(s) based at least in part on the purpose of the mentorship relationship.

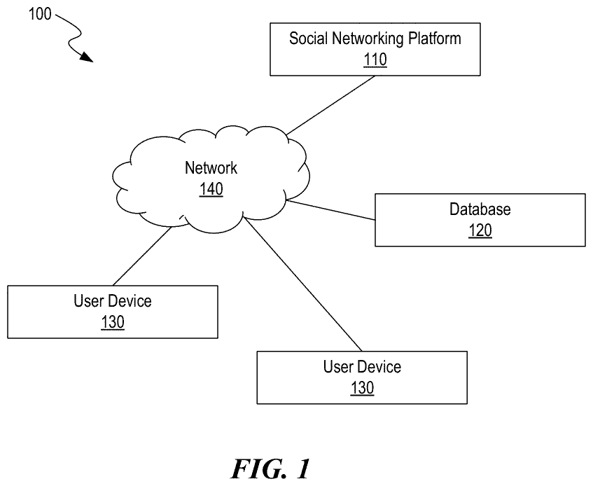

FIG. 1 is a block diagram illustrating a social networking system 100 (“system 100”) for facilitating social networking, according to some embodiments. As shown, the system 100 includes a social networking platform 110 (“platform 110”), a database 120, and one or more user devices 130 communicatively coupled over a network 140. The system 100 can include additional or different entities than shown in FIG. 1. For example, the system 100 may include multiple databases 120 or user devices 130, or can include other intermediate systems that transfer data between the database 120 and user device 130.

The user device 130 operated by a user can be in communication with the platform 110 and the database 120 over the network 140, such as the Internet. The user can use the user device 130 to provide data to the platform 110. The data can include, but not limited to, profile attributes, role (e.g., mentor, mentee, and/or general member), match preferences, media files (e.g., photos, videos, and audio files), and/or any other suitable information. The profile attributes can include, but are not limited to, an age, age range, gender, interests, work experience, location, and/or any other suitable information of the user. The location can be a current location, real-time location, and/or previous location (e.g., hometown). The user can also use the user device 130 to access content on the platform 110 or to interact with other users of the social network system. Furthermore, the user device 130 can include a sensor, such as a global positioning system (GPS) sensor, capable of detecting a current location of the user device.

The platform 110 facilitates matching, networking, and/or community building for a plurality of users. The platform 110 enables a variety of functionalities. For example, the functionalities include, but is not limited to, viewing a user profile, uploading and/or sharing media files (e.g., pictures and photos), sharing contact information, participating in a matching program, viewing a match, accepting, declining and/or saving the match, requesting a connecting, sending a message to another user, creating a group chat and/or public forum, and/or other functionalities discussed herein. For example, a user is able to create a user profile, participate in a matching program, message other users, create and register to events, upload and share media files via the platform 110.

The database 120 receives and stores digital data. The database 120 can include one or more computing devices capable of communicating data over the network 140, such as a server, a personal computer, or a mobile phone. In some embodiments, the database 120 includes cloud storage. The database 120 can organize and store data associated with the platform 110, such as information explicitly or implicitly provided by the users to the platform 110, information related to users' interactions with each other or with objects in the platform 110, or information derived from other types of information on the platform.

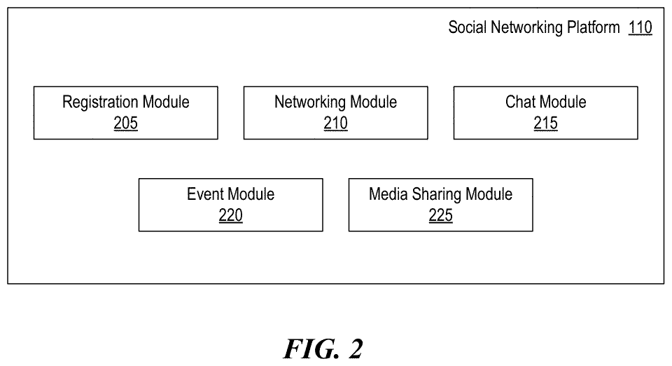

FIG. 2 is a functional logic diagram for the platform 110 for facilitating matching, networking, and/or community building, according to some embodiments. As shown, embodiments of the platform 110 include a registration module 205, networking module 210, chat module 215, event module 220, and media sharing module 225.

The user can register (e.g., sign up, create an account, provide information, etc.) to access the platform 110 via the registration module 205. Upon registration, the user can participate in the matching program to be matched to another user (e.g., to a mentor and/or mentee) and/or connect with other users via the networking module 210. The user can message another one or more users and/or one or more matches via the chat module 215. The user can create, view, and/or register to attend one or more events via the event module 220. The user can upload, share, and/or provide comments on one or more media files (e.g., the digital entities as described in reference to FIG. 1) via the media sharing module 225.

The platform 110 can include additional or different entities than shown in FIG. 2. For example, the platform 110 may include a donation module for accepting donations. For example, the donation module can include a donation button on a user interface of the platform 110. The donation module can display the donation button to the user. Upon the user's selection of the donation button, the donation module can prompt the user to make a donation and process the donation.

In some embodiments, the platform 110 includes one or more access levels. The platform 110 can assign one or more access levels to the user based on any suitable criteria. For example, each access level can be assigned to the user based on the user's role. The one or more access levels can include any suitable number of access levels (e.g., one, two, three, four, five, ten, twenty, thirty, and fifty). For example, the one or more access levels can include a first access level, second access level, and third access level. The first access level can be assigned to a user registered as a mentee. The second access level can be assigned to a user registered as a mentor. The third access level can be assigned to a user registered as a general member.

In some embodiments, the platform 110 determines a user's access to the functionalities of the platform 110 based on the access level assigned to the user. For example, the platform 110 can restrict or enable the ability to initiate a chat for the user based on the access level. For example, a user assigned to the first access level (e.g., a mentee) can initiate a chat with a match (e.g., potential mentor), whereas a user assigned to the second access level may not initiate a chat. In another example, the platform 110 can restrict or enable the ability to participate in the matching program. For example, a user assigned to the third access level may not participate in the matching program.

In some embodiments, the platform 110 can restrict and/or enable the user to create, view, and/or register to an event based on the access level assigned to the user. For example, users assigned to the first, second, and/or third access level can create, view, and/or register to an event. In another example, only users assigned to the first access level can create, view, and/or register to an event. In yet another example, only users assigned to the second access level can create, view, and/or register to an event. In yet another example, only users assigned to the third access level can create, view, and/or register to an event. In yet another example, only users assigned to the first and second access level can create, view, and/or register to an event.

In some embodiments, the platform 110 can display a set of user interfaces based on the access level assigned to the user. A set of user interfaces for one access level can be the same or different from a set of user interfaces for another access level. For example, a set of user interfaces for the first access level may be different than a set of user interfaces for the second access level. The user interfaces can be tailored to the user's role. For example, the user interface for the first and/or second access level (e.g., for users participating in the matching program) can include a matching button (e.g., “Match Me”) to initiate the matching functionality of the platform 110, whereas the user interface for the third access level (e.g., for users with the role as a general member) may not include the matching button.

In some embodiments, the platform 110 can determine viewing restrictions for a user based on the access level assigned to the user. For example, the access levels can define restrictions to view a directory (e.g., a directory of mentors, mentees, general members, and/or all users), user profiles, a portion of a user profile, and/or uploaded media files. For example, the platform 110 can restrict users with the first access level to view only the user profile of users with the second access level (e.g., mentees can view only user profiles of mentors). In another example, users with the first access level can view only the user profile of users with the second and third access level (e.g., mentees can view user profiles of mentors and general members). In another example, users with the first access level can view the user profile of users with the first, second and third access level (e.g., mentees can view user profiles of all registered users). In yet another example, users with the second access level can view only the user profile of users with the first access level (e.g., mentors can view only user profiles of mentees). In yet another example, users with the second access level can view only the user profile of users with the first and third access level (e.g., mentors can view user profiles of mentees and general members). In yet another example, users with the second access level can view the user profile of users with the first, second and third access level (e.g., mentors can view user profiles of all registered users). In yet another example, users with the third access level can view the user profile of users with the third access level (e.g., general members can view only user profiles of general members).

In some embodiments, the platform 110 enables users to access the platform 110 based on the user's work experience. For example, only users with work experience from a specific employer can register to access the platform 110 and/or participate in the matching program. For example, the employer can be the United States Department of Defense, and only users who worked for the United States Department of Defense can register to the platform 110 and/or participate in the matching program. In another example, the employer can be the United States Armed Forces, and only users who worked in the United States Armed Forces can register to the platform 110 and/or participate in the matching program.

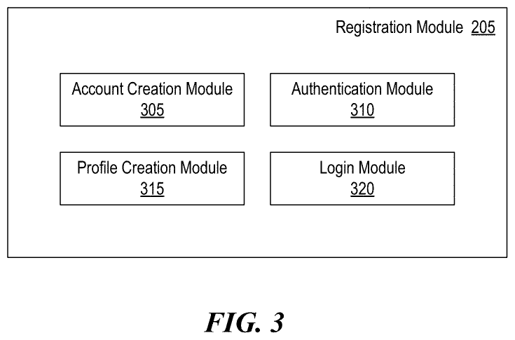

FIG. 3 is a functional logic diagram for the registration module 205 for enabling users to access the platform 110, according to some embodiments. The registration module 205 enables a user of the platform 110 to create an account, provide information, and login to the platform 110. As shown, the registration module 205 includes an account creation module 305, authentication module 310, profile creation module 315, and login module 320. The registration module 205 can include fewer, additional, or different entities than shown in FIG. 3. For example, the registration module 205 may not include the authentication module 310.

The account creation module 305 can provide a user interface to a first-time user to create an account and input user information. In some embodiments, in order to access the platform 110, the user is required to create a personal account and provide user information. The user information can include a user name, password, and/or at least one of an email address, phone number, or any other suitable third-party account information. Alternatively, the user can register using existing social network credentials, such as via LinkedIn, Facebook, Instagram, or other suitable third-party social networks. The user information can further include, but is not limited to, attributes such as an age, age range, ethnicity, birth date, gender, interests, work experience, and/or location. In some embodiments, the user information can be extracted from an existing social network account (e.g., LinkedIn, Facebook, and Instagram). Location can be provided manually by the user or dynamically provided based on IP address, GPS location, or other technique.

In some embodiments, the account creation module 305 prompts the user to indicate a role. For example, the role can be a mentor, mentee, and/or general member. Mentors and mentees can be defined as users who participate in the matching program. General members can be defined as users who may access the platform 110 and not participate in the matching program.

In some embodiments, the account creation module 305 enables users to register with one or more roles. In some embodiments, the account creation module 305 allows the user to register to only one role. For example, the user can register as only a mentor, only a mentee, or only a general member. In other embodiments, the account creation module 305 allows the user to register to two or more roles. For example, the user can register as a mentor and mentee. The user can be a mentor to one or more mentees, and the user can be a mentee to one or more mentors. In some embodiments, the account creation module 305 provides only two roles (e.g., mentor and mentee). For example, only mentors and mentees can access the platform 110.

Upon creating an account, the user can be verified via the authentication module 310. In some embodiments, the user must be verified in order to access and use the platform 110. The authentication module 310 can verify the identity of the user, determine and/or approve the role of the user (e.g., mentor, mentee, and/or general member), and/or assign the access level of the user. For example, the authentication module 310 can use third-party account information and/or existing social network credentials provided by the user to verify the identity of the user.

In some embodiments, the authentication module 310 can approve and/or deny a user-indicated role and/or assign a role. The authentication module 310 can approve, deny, and/or assign a role based on a set of criteria. The set of criteria can include work experience/history (e.g., military veteran). For example, the authentication module 310 can approve a user with at least a number of years of experience (e.g., at least 5, 10, 20, 30 or 40 years) a user-indicated role of mentor. In another example, the authentication module 310 can approve a user with less than a number of years of experience (e.g., less than 1, 3, 5, 10, 20, 30 or 40 years) a user-indicated role of mentee. In some embodiments, the authentication module 310 automatically approves the user-indicated role.

Upon authentication (if applicable), the profile creation module 315 can create a user profile of the user. The user profile can be viewable by the user and other users. The user profile can display any suitable components. The user profile can be populated with the user information provided during registration. For example, the user profile can display a user name, unique user identifier, user contact (e.g., email, telephone number, etc.), picture (e.g., photo), role (e.g., mentor, mentee, and general member), and/or other attributes (e.g., age, gender, ethnicity, interests, work experience, and location). In a further example, the user profile can display an event that the user created, registered to, and/or attended. In another example, the user profile can display one or more media files (e.g., audio, video, picture, and document). For example, the one or more media files can be uploaded by the user. In another example, the user profile can display the user names of mentor(s) and/or mentee(s) of the user. In some embodiments, the user profile can display a chat button that enables another user to initiate chatting with the user.

In some embodiments, the profile creation module 315 can determine and display the user information on the user profile based on the access level assigned to the user. For example, the profile creation module 315 may display information on a user profile for a user assigned to the first access level and/or second access level different than information on a user profile assigned to the third access level. For example, a user profile for a user registered as mentor and/or mentee may include a list of mentees and/or mentors of the user. In another example, a user profile for a user registered as a general member may not include the list since general members do not participate in the matching program.

In some embodiments, the profile creation module 315 can create one or more directories of users. For example, the profile creation module 315 can populate a first directory with registered users, second directory with users registered as a mentor, third directory with users registered as a mentee, and/or fourth directory with users registered as a general member. The directory can display the unique user identifier and/or user name of each registered user. In some embodiments, the directory is a searchable (e.g., filterable) directory. For example, a user can search the directory by applying one or more filters (e.g., age, gender, ethnicity, interests, work experience, and location).

The user can login to the platform 110 via the login module 320. The login module 320 can provide a login screen featuring user credential fields (e.g., unique user identifier and password) for user access to the platform 110. The user can enter user credentials to access various functionalities of the platform 110.

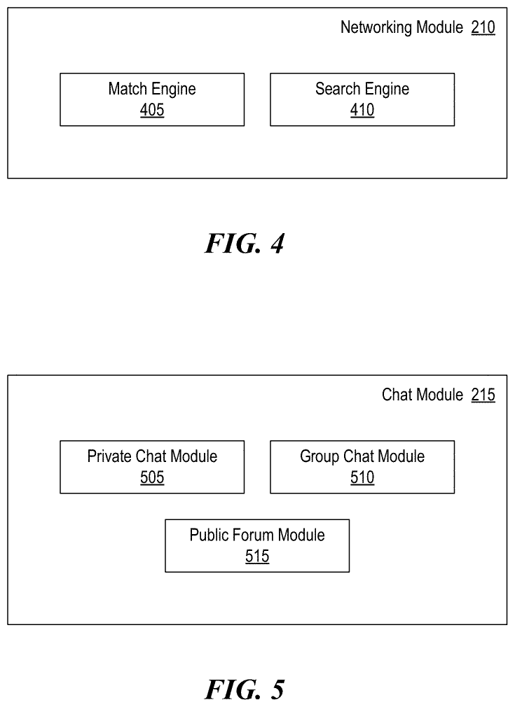

FIG. 4 is a functional logic diagram for the networking module 210 for facilitating matching and forming connections (e.g., networking), according to some embodiments. As shown, the networking module 210 includes a match engine 405 and search engine 410. The match engine 405 generates and recommends matches (e.g., potential mentors and/or mentees) to a user participating in the matching program. For example, the match engine 405 can identify potential mentors for users registered as a mentee. In another example, the match engine 405 can identify potential mentees for users registered as a mentor. The search engine 410 enables users to search through a directory of mentors and/or mentees. The networking module 210 can include less, additional, or different entities than shown in FIG. 4. For example, the networking module 210 may include only the match engine 405 or only the search engine 410. In another example, the networking module 210 may include other engines for facilitating matching users to find mentor(s) and/or mentee(s).

In some embodiments, the match engine 405 identifies matches (e.g., potential mentors and/or mentees) for the user using a heuristic. The match engine 405 can use a set of criteria to identify matches. The set of criteria can include, but is not limited to, match preferences provided by the user. For example, the user-provided match preferences may include an age range, gender, work experience, and/or location. In some embodiments, the set of criteria includes only the user-provided match preferences. In other embodiments, the set of criteria includes user-provided match preferences and additional criteria (e.g., provided by an operator and/or preset by the platform 110). The additional criteria include any suitable attributes, including but not limited to, age range, gender, ethnicity, interests, work experience, or location.

In some embodiments, the match engine 405 identifies matches (e.g., potential mentors and/or mentees) for the user using a machine learning model. The machine learning model can be trained with the user profiles of pairs of users who have matched via the platform (such as pairs of users with established mentor-mentee relationships). For example, the model can be trained to generate scores representing a likelihood that a first user will be a good mentoring match for a second user, based on the user profiles of the first and second users. If the score is greater than a specified threshold, the match engine 405 recommends the first user to the second user or vice versa. Once the match engine 405 recommends a match between users based on application of the machine learning model, the match engine 405 can use the users' response to the match to improve the model. For example, if the first and second user accept the match, the profiles of the first and second user can be added to a training set for the model as a positive training datapoint. If the first and second users reject the match, the profiles of the first and second user can be added to the training set as a negative training datapoint.

In some cases, the match engine 405 applies multiple machine learning models to recommend matches between users, where each model is trained to identify matches for different purposes. One model, for example, can be trained to recommend users that are likely to be a good mentor to a given user, while another model can be trained to recommend users to chat with a given user.

In some embodiments, the match engine 405 identifies matches (e.g., potential mentors and/or mentees) for the user using a rules-based model. The rules-based model includes one or more rules that, if satisfied by the user profiles of two users, recommends a match between the two users. Some of the rules may match users if the users have a similar profile attribute. One example rule matches users who have similar work experience, such as identifying a match for a user who has the most similar work experience to the user. Similar work experience can be defined as, but not limited to, working for a same employer, in a same organization, department and/or branch, and receiving similar work titles (e.g., lieutenant, general, etc.). In a further example, if the user served in a particular branch of the United States Armed Forces, the simple model identifies matches that have served in the same particular branch of the United States Armed Forces. For example, the particular branch can include the Army, Marine Corps, Navy, Air Force, Space Force, or Coast Guard. Other example rules match users who have the same or similar interests, ages that are within a threshold distance from each other, ages that are greater than a threshold distance from each other, or geographic locations less than a threshold distance apart. Furthermore, some rules may require users to have multiple similar profile attributes in order to match the users.

In some embodiments, the rules-based or machine learned models applied by the match engine 405 use a purpose of a mentorship match, in addition to the user profiles, to generate recommendations for mentors or mentees. The purpose of a mentorship match can have any degree of specificity. Example purposes associated with mentorship relationships include navigating civilian life after leaving the military, starting a business, enrolling in health insurance, or arranging childcare in Colorado Springs, Colo. As users of the social network have varying levels of experience with different mentorship purposes, identifying users with specific mentorship needs or capabilities can help improve the utility of the social network for the users.

In some cases, the purpose of the mentorship relationship may be explicitly indicated by a user. For example, the social networking system can allow a user to enter freeform text or select from a list of predetermined options indicating the purpose for which the user seeks a mentor.

Additionally or alternatively, the match engine 405 can automatically identify recommended purposes based on the user profiles or input from other users. Some mentorship needs may be determined based on changes in user profiles. For example, if a user changes her profile to indicate that she recently adopted a baby, the match engine 405 can detect that the user's profile was updated, parse the profile update by any of a variety of natural language processing techniques to determine that the updated indicates adoption of a child, and identify child adoption as a potential mentorship purpose. Other mentorship needs can be identified based on information provided by other users of the social network. For example, if users who started businesses indicated that they needed help navigating a Series A financing round an average of one year after starting their companies, the match engine 405 identifies a user who started a company approximately one year ago and recommends the user pursue a mentorship relationship around navigating the Series A financing. In addition to or instead of identifying mentorship purposes based on the mentoring needs of a potential mentee, the match engine 405 can identify mentorship purposes based on the mentoring capabilities of potential mentors. Potential mentors can, for example, provide explicit information to the social network indicating their skills or experiences. In other cases, the match engine 405 extracts information from the user profiles of potential mentors to determine capabilities. For example, the match engine 405 extracts information that a user has greater than a threshold number of years of entrepreneurship experience, or is a parent, or earned a particular professional certification.

Once a mentorship purpose has been identified, the match engine 405 can apply one or more models, such as trained machine learning models, rules-based models, or a combination thereof, to identify potential mentor/mentee matches based on the user profiles of the users and the mentorship purpose associated with at least one of the potential mentors or mentees.

Upon identifying mentor or mentee matches, the match engine 405 notifies the user. The notification can be in the form of a recommendation and/or suggestion. For example, the match engine 405 can send a message to the user (e.g., “You have a new recommended match.”). In some embodiments, the message includes a reason for the match (e.g., “Match User A is located within 5 miles from you,” “Match User A shares similar interests to you,” “Match A considers himself an expert at navigating Series A financing,” etc.).

In some embodiments, the match engine 405 displays a list of matches to the user. The user can view the list. The user can select a match from the list to view additional information. For example, upon receiving an indication that the user selects a match from the list, the match engine 405 can provide at least a portion of the user profile of the match to the user.

In some embodiments, the match engine 405 displays at least a portion of the user profile of a match to the user. The user can view one match at a time on a user interface displayed on the device 130. The match engine 405 may prompt the user to take an action prior to displaying at least a portion of a user profile of another match to the user. The action can include, but is not limited to, view, request a connection, accept a connection, reject a connection, and/or save. For example, the user can view additional information of the match. In another example, the user can request a connection with the match. In another example, the user can accept and/or reject the match and/or connection request. In yet another example, the user can save the match to view, request a connection, accept a connection, and/or reject a connection at a different time.

Upon receiving an indication that the user requests a connection with the match, the match engine 405 can notify the match. For example, the match engine 405 may send a message to the match (e.g., “New connection request”). The match can view, accept the connection, reject the connection, and/or save the user. For example, the match can view at least a portion of a user profile and/or additional information of the user. In another example, the match can accept and/or reject the user and/or connection request. In yet another example, the match can save the user to view, accept the connection, and/or reject the connection at a different time.

The match engine 405 can notify the user and/or the match in a variety of ways. In some embodiments, the match engine 405 notifies the user and/or the match that a connection is made only when both the user and match mutually accept the connection. In some embodiments, the match engine 405 notifies the match when the user requests a connection. In some embodiments, the match engine 405 notifies the user when the match accepts the connection. In some embodiments, the match engine 405 does not notify the user when the match rejects the connection.

In some embodiments, the match engine 405 enables additional functionality based on the status of the connection. For example, the chat functionality of the platform 110 can be enabled when the user and the match form a connection (e.g., the match accepts the user's connection request). In another example, the chat functionality is enabled only for the user if the user is registered as a mentee. In yet another example, the chat functionality is enabled only for the user if the user is registered as a mentor.

The match engine 405 can enable the user to take the action (e.g., view, request a connection, accept the connection, reject the connection, and/or save a match) in a variety of ways. In some embodiments, the match engine 405 can include a button for each of the actions. For example, the user may click a view button, request button, accept button, reject button, and/or save button. In some embodiments, the match engine 405 can configure a motion-sensing modality. For example, the user can hold a finger on a user name and swipe up and/or down to view additional information. In another example, the user can hold and swipe right to accept the match. In yet another example, the user can hold and swipe left to reject the match.

In some embodiments, the match engine 405 can display a chat button. The user can request a connection and/or accept a match via clicking on the chat button. For example, the user can click the chat button to initiate the chat box. Upon initiating the chat box, the match engine 405 may notify the match that the user requested and/or accepted the match as a mentor and/or a mentee. In some embodiments, the user can message the match prior to and/or after accepting a match. For example, the user can message the match and then accept or reject the connection at a later time.

In some embodiments, the match engine 405 selects the action for the user and/or the match. The match engine 405 can select the action for the user and/or the match in a variety of ways. For example, the match engine 405 enables the user to opt-in for the match engine 405 to take particular actions for the user. For example, the match engine 405 can accept a connection request for the user and/or the match (e.g., forgoes approval from the user and/or the match).

In some embodiments, the match engine 405 can receive analytics, reports, and/or other information, which can be used to generate improved future matches for the user. For example, the match engine 405 can receive user information (e.g., age, gender, interests, work experience, location, etc.) of the accepted or rejected match and use the information in the machine learning model to generate improved matches for the user. In some embodiments, the match engine 405 can receive feedback from the user directly. For example, the user may provide feedback including reasons the user accepted or rejected the match.

The search engine 410 enables the user to search through one or more directories of a plurality of users. The search engine 410 can display the one or more directories to the user. The user can view the directory, apply a search filter, and/or view a subset of the directory. The search engine 410 can generate the one or more directories. The one or more directories can include, but is not limited to, a full directory (e.g., a directory of all users), mentor directory (e.g., a directory of all users registered as a mentor), mentee directory (e.g., a directory of all users registered as a mentee), and/or general member directory (e.g., a directory of all users registered as a general member). Via the search engine 410, the user can identify a mentor, mentee, and/or a general member. The user can ping (e.g., send a private message, invite to a group chat, and invite to a public forum) another user from the one or more directories.

The search engine 410 can prompt the user to create a search within the one or more directories. The search engine 410 can provide categories for the search. For example, the categories can include, but is not limited to, an age, age range, gender, ethnicity, interests, work experience, and/or location. The user can define one or more criteria for one or more categories. For example, the user can indicate 40 to 60 years old, female, Asian, served in the United States Army Special Forces, and lives in Virginia. The search engine 410 generates a search result (e.g., a list) based on the user-inputted criteria. The user can view and/or save the search result. The user can select from the search result to view at least a portion of a user profile. The user can ping another user from the search result. The search result can be saved in the database 120.

In some embodiments, the search engine 410 includes a geo-locating function. For example, the user may search for other users within a certain proximity (e.g., 1, 5, 10, and 20 miles) of the user. The geo-locating function can include notifying the user if another user is within a certain proximity of the user. The user can create geo-locating notification criteria. For example, the user may specify the geo-locating notification criteria to include users who are 40 to 60 years old, female, Asian, served in the United States Army Special Forces, and are within 5 miles of an indicated location and/or real-time location of the user. The search engine 410 can notify the user when the criteria are met.

FIG. 5 is a functional logic diagram for the chat module 215 for enabling the user to communicate with another user, according to some embodiments. The chat module 215 enables communication between users in a variety of ways. The chat module 215 includes a private chat module 505, group chat module 510, and public forum module 515. The chat module 215 can include less, additional, or different entities than shown in FIG. 5. For example, the chat module 215 may include only the chat module 505, only the group chat module 510, or only public forum module 515. In another example, the chat module 215 may include only the chat module 505 and group chat module 510.

The private chat module 505 enables the user to discretely message other users. The user can send and received threaded messages. The group chat module 510 enables the user to create semi-private groups and invite any number of other users into those groups. The users can read and write to messaging windows. The public forum module 515 enables the user and/or an operator (e.g., administrator of the platform 110) to create, name and manage one or more public forums (e.g., open blogs). Any user can join the public forum and read and write to it. In some embodiments, only a subset of users can access the public forum. For example, the public forum module 515 may restrict access to a public forum to only users who meet at least one criterion. For example, the at least one criterion can include, but is not limited to, being registered as a mentor, mentee, and/or general member, age, age range, interests, work experience, and/or location.

In some embodiments, the messaging can be instant messaging (e.g., a real-time direct text-based chatting communication in push mode between two or more users using devices). “Push mode” refers to a mode which does not require user-implemented prompts. The chat module 215 can instantly notify the user if other users have communicated with them. The chat module 215 can identify those users and the time and date of their messages.

The chat module 215 can facilitate the transmission of a variety of file types between users. In some embodiments, the chat module 215 enables messaging of audio files (e.g., MP3, FLAC, WAV, etc.), video files (e.g., AVI, MOV, SWF, FLV, MP4, etc.), and picture files (e.g., JPEG, TIFF, BMP, GIF, PNG, etc.), and/or documents (e.g., DOC, PDF, RTF, PPT, XLS, etc.). For example, the user can record and send an audio and/or video file to a private chat, group chat, and/or public forum.

The chat module 215 can facilitate communication via a variety of ways. In some embodiments, the chat module 215 includes real-time audio and/or video calling (e.g., conferencing). For example, the user can audio and/or video call another one or more users via the chat module 215. The chat module 215 can enable audio and/or video call between two or more users in a private call, semi-private group call, and/or a public call. The user can communicate with another user in a private audio and/or video call. The user can create a semi-private group and invite any number of other users into the group to communicate in a semi-private group call. The user and/or the operator can create a public call, in which all users and/or a subset of users can join. For example, the subset of users can include only users that meet at least one criterion. For example, the at least one criterion can include, but is not limited to, being registered as a mentor, mentee, and/or general member, age, age range, interests, work experience, and/or location.

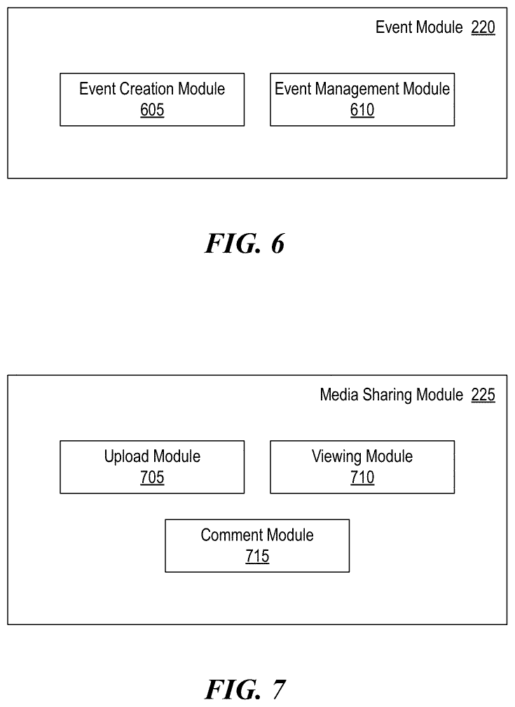

FIG. 6 is a functional logic diagram for the event module 220 for managing events, according to some embodiments. The event module 220 includes an event creation module 605 and event management module 610. The event module 220 can include less, additional, or different entities than shown in FIG. 6. For example, the event module 220 may include only the event creation module 605 or only the event management module 610.

The event creation module 605 enables users to create, view, and/or register for events. The user can create a private event or public event. The user can create a private event and invite any number of other users to the private event. The user can create a public event, in which all users and/or a subset of users can discover and/or join. For example, the subset of users can include only users that meet at least one criterion. For example, the at least one criterion can include, but is not limited to, being registered as a mentor, mentee, and/or general member, age, age range, interests, work experience, and/or location.

The event management module 610 can cluster similar events together, recommend relevant event clusters and/or events to a user based on the user's interests, relevance, and/or latest activities. The event management module 610 can manage discovery and clustering. The event management module 610 can recommend event clusters and/or events to the user based on interests, relevance, latest activities, and/or activities of other users associated with the user. For example, an associated user can include, but is not limited to, a mentor and/or a mentee of the user, another user in a private chat, group chat, and/or public forum with the user.

The event management module 610 can generate an event directory. The event management module 610 can populate the event directory with events created by users of the platform 110. The event management module 610 can display the event directory to the user. The event directory can be displayed to the user based on categories. The categories can be determined based on the event clusters. The event directory can be a searchable directory. For example, the user can apply one or more filters to search the event directory. The user can save the search results. The search results can be stored in the database 120.

FIG. 7 is a functional logic diagram for the media sharing module 225 for facilitating matching of users, according to some embodiments. The media sharing module 225 includes an upload module 705, viewing module 710, and comment module 715. The media sharing module 225 can include less, additional, or different entities than shown in FIG. 7. For example, the media sharing module 225 may include a sharing module such that users can share uploaded media files.

The upload module 705 enables the user to upload media files. The upload module 705 can populate a media directory with the uploaded media files. In some embodiments, the media directory includes a photo directory. For example, the upload module 705 can populate the photo directory with uploaded media files that are pictures and/or photos. In some embodiments, the photo directory includes a subset of the pictures and/or photos in the media directory. In other embodiments, the photo directory includes pictures and/or photos not in the media directory.

In some embodiments, the upload module 705 includes one or more community forums. The user and/or the operator can create the one or more community forums. The user can upload one or more media files to the one or more community forums. The media files can include, but is not limited to, audio files (e.g., MP3, FLAC, WAV, etc.), video files (e.g., AVI, MOV, SWF, FLV, MP4, etc.), and picture files (e.g., JPEG, TIFF, BMP, GIF, PNG, etc.), and/or documents (e.g., DOC, PDF, RTF, PPT, XLS, etc.). The upload module 705 can store the media files in the database 120. The user can include one or more tags associated with the media file (e.g., sunset, flag, nature, people, etc.).

The viewing module 710 can display the uploaded media files in the community forum in a variety of ways. For example, the viewing module 710 can display the media files individually, in a list, in a grid, and/or in other suitable ways. In another example, the viewing module 710 can display the media directory to the user. The media directory can be searchable. For example, the user can apply one or more filters to search the media directory. The user can select an individual file to open and/or change the viewing size (e.g., enlarge). In some embodiments, the viewing module 710 includes media categories. The viewing module 710 can cluster similar media files into each media category. For example, the viewing module 710 may cluster media files based on the media file type (e.g., JPEG, MP4, PDF, etc.), the user who uploaded the media file, attributes of the user who uploaded the media file, and the one or more tags associated with the media file.

In some embodiments, the viewing module 710 can determine an order of displaying media files and/or which media files to display to the user based on a determined relevancy. The determined relevancy can be based on media categories and/or one or more user filters. For example, the viewing module 710 can display, to the user, media files that were uploaded by other users associated with the user (e.g., the user's mentor and/or mentee). In a further example, the user can indicate the one or more user filters to include, but not limited to, tags, users, media file type, and/or other suitable filters.

The comment module 715 enables users to write and upload comments for the media files. For example, the user can write to a comments section to be viewed privately, semi-privately, and/or publicly. Users can upvote and/or downvote the comments. The comment module 715 can determine an order of displaying the comments. The order can be based on a timestamp, relevancy, and/or number of upvotes and/or downvotes.

The media sharing module 225 can enable the user and/or operator to determine viewing and/or commenting restrictions. For example, the user and/or operator can create a community forum and open the community forum to all users and/or restrict the community forum to a subset of users. For example, the subset of users can include only users that meet at least one criterion. For example, the at least one criterion can include, but is not limited to, being registered as a mentor, mentee, and/or general member, age, age range, interests, work experience, and/or location.

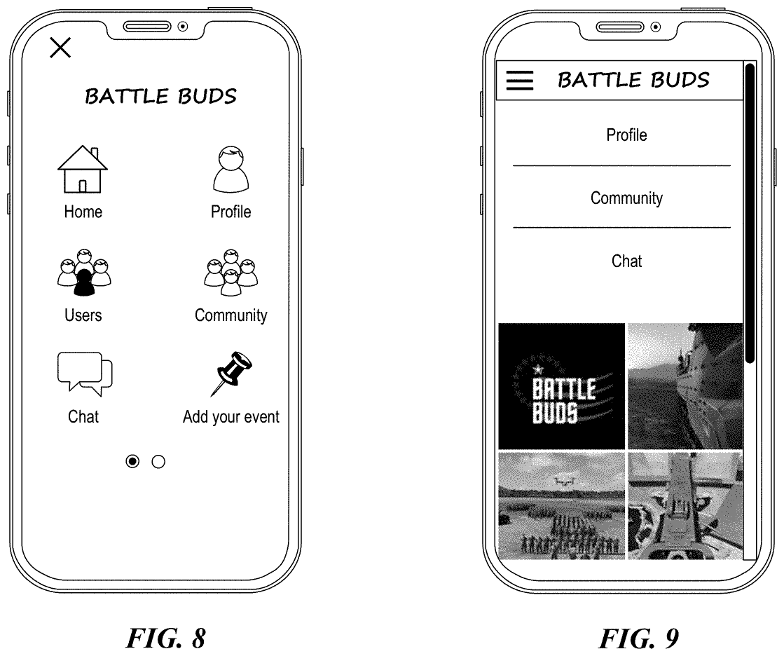

FIG. 8 is a functional screen diagram for social networking within the system 100, according to some embodiments. A welcome screen can display a variety of buttons, graphics, and/or icons. As shown, the welcome screen displays a home button, profile button, users button, community button, chat button, and event creation button. The welcome screen can display less, additional, or different entities than shown in FIG. 8. For example, the welcome screen may include a matching button for initiating the matching program, viewing matches, and/or accessing other functionalities associating with the matching program (e.g., via the networking module 210). In a further example, the home screen may include an event button for viewing and/or registering to events. The user may swipe left or right to view additional buttons.

The home button is associated with a home screen (e.g., as shown in FIG. 9). The user can select the profile button to be redirected to a user interface to access (e.g., view and edit) his/her user profile (e.g., via the profile creation module 315). The user can select the users button to be access the directories and/or other user profiles. The user can select the community button to access the community forum (e.g., via the media sharing module 225). The user can select the chat button to access the chat functionalities (e.g., via the chat module 215). The user can select the event creation button to create an event (e.g., via the event creation module 605).

FIG. 9 is a functional screen diagram for social networking within the system 100, according to some embodiments. As shown, the home screen displays profile button, the community button, the chat button, and media files (e.g., pictures). The user can select one of the media files to be redirected to access the community forum. In some embodiments, selecting one of the media files opens and/or enlarges the view of the media file. The home screen can display less, additional, or different entities than shown in FIG. 9. For example, the home screen may include the matching button, notifications (e.g., “New Match!”), upcoming events, etc.

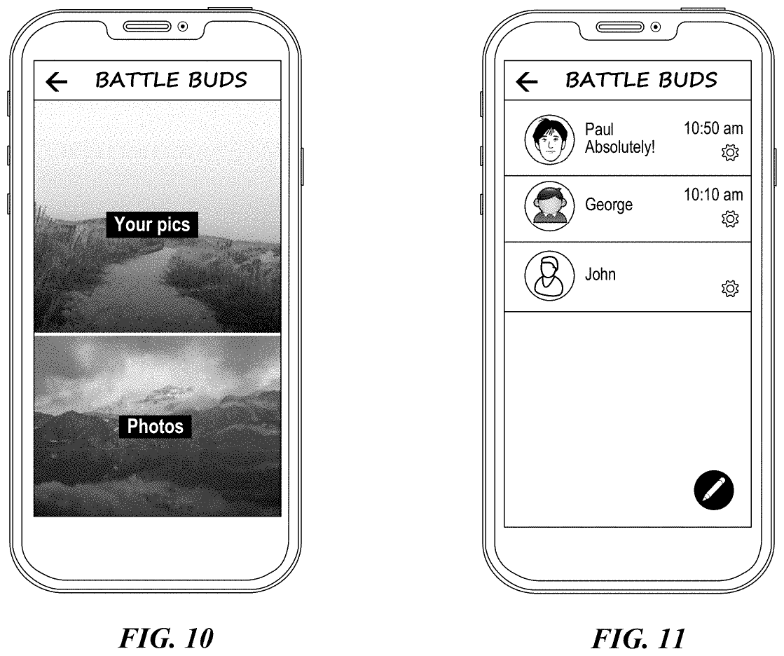

FIG. 10 is a functional screen diagram for social networking within the system 100, according to some embodiments. As shown, a community forum screen displays a “Your pics” button, “Photos” button, and a back-arrow button for returning to a previous user interface and/or return to the home screen. The user can select the “Your pics” button to access and view pictures that the user uploaded (e.g., via upload module 705). The user can select the “Photos” button to access and view pictures that other users uploaded (e.g., via upload module 705). The community forum screen can display less, additional, or different entities than shown in FIG. 10. For example, the community forum screen may include filters and/or categories for a user to select which type of media file to view.

FIG. 11 is a functional screen diagram for social networking within the system 100, according to some embodiments. As shown, a chat screen displays message threads between a user and other users, a new message button (as shown in the bottom-right corner of FIG. 11), and a back-arrow button for returning to a previous user interface and/or return to the home screen. The chat screen can display the messages in any suitable order. For example, the messages can be displayed in chronological order (e.g., based on the timestamp of the message sent to the user). The chat screen can display less, additional, or different entities than shown in FIG. 11. For example, the chat screen may include categories for sorting messages (e.g., unread/read messages).

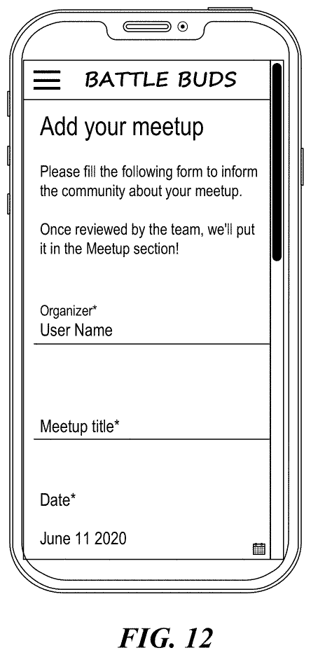

FIG. 12 is a functional screen diagram for social networking within the system 100, according to some embodiments. As shown, an event creation screen displays a form with input fields for a user to input event information. The user can input a variety of information, including but not limited to, a user name, event title, event date, event description, attendees list, and/or any other suitable event information.

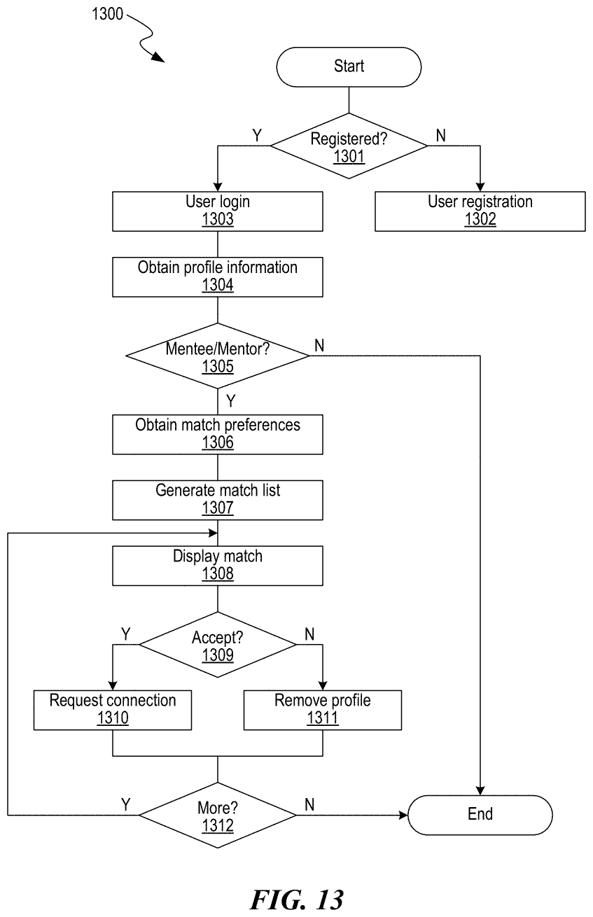

FIG. 13 is a flow chart of an example of a method 1300 for using the social networking platform. The example of FIG. 13 is intended to illustrate how a user can use the social networking platform to participate in the matching program. The method 1300 is illustrated as serially arranged blocks and decision points, but it should be noted that the flowchart could be reordered or arranged for parallel execution of certain blocks.

In the example of FIG. 13, the method 1300 starts at decision point 1301 with determining whether the user registered to the social networking platform. If the user is not registered, the method 1300 proceeds to block 1302 with receiving an indication from the user to register to the social networking platform. The user can provide user credentials (e.g., user name, email address, phone number, password, etc.) as the indication. Upon registration or if user is already registered, the method 1300 proceeds to block 1303 with executing a user login. In an implementation in which a user accesses the social networking platform using a mobile device, the user login and/or registration can be accomplished through an app that is running on the mobile device or through a web site if the mobile device is web-enabled. In an implementation in which the user accesses the social networking platform using a desktop computer, the user login and/or registration can be accomplished through a web site that is running on the desktop computer.

In the example of FIG. 13, the method 1300 continues to block 1304 with obtaining profile information from the user. The user can provide the profile information including, but not limited to, an age, age range, ethnicity, interests, work experience, and/or location of the user. The user can indicate a role (e.g., mentor, mentee, and/or general member). The method 1300 continues to decision block 1305 with determining whether the user indicated a role of mentee. If the user did not indicate the role of mentee and/or mentor (e.g., the user indicated the role of general member), the method 1300 ends. If the user indicated the role of mentee and/or mentor, the method 1300 proceeds to block 1306 with obtaining match preferences from the user. The user can provide the match information including, but not limited to, an age, age range, ethnicity, interests, work experience, and/or location of other users.

In the example of FIG. 13, upon receiving the match preferences, the method 1300 proceeds to block 1307 with generating a match list based on the user's match preferences. The method 1300 proceeds to block 1803 with displaying a match from the match list to the user. In an implementation, the method 1300 can display at a least a portion of a user profile of the match to the user.

In the example of FIG. 13, the method 1300 continues to decision block 1308 with determining whether the user accepts the match. If the user accepts the match, the method 1300 proceeds to block 1309 with requesting a connection with the match. In an implementation, after a connection is requested, the user can be given the option to withdraw a request that has not been accepted, or the request can time out after a predetermined and/or a configurable period of time (not shown). If the user does not accept (e.g., rejects) the match, the method 1300 proceeds to block 1310 with removing the profile from the match list of the user. The method 1300 continues to decision block 1311 with determining whether more matches are available in the match list. If more matches in the match list are available, then the method 1300 returns to block 1307. If no more matches are available in the match list, then the method 1300 ends.

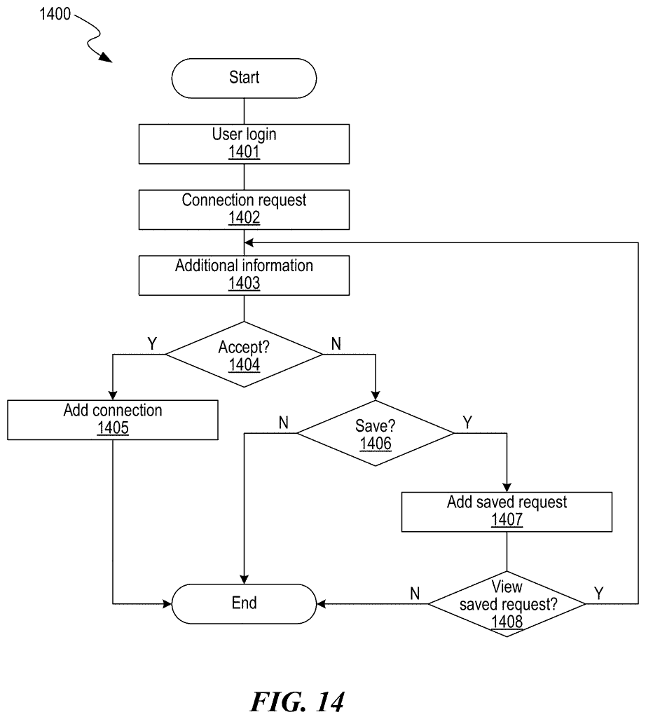

FIG. 14 is a flow chart of an example of a method 1400 for using the social networking platform. The example of FIG. 14 is intended to illustrate how a user (e.g., a mentor and/or mentee) can use the social networking platform to participate in the matching program. The method 1400 is illustrated as serially arranged blocks and decision points, but it should be noted that the flowchart could be reordered or arranged for parallel execution of certain blocks.

In the example of FIG. 14, the method 1400 starts at block 1401 with executing a user login. In an implementation in which a user accesses the social networking platform using a mobile device, the user login can be accomplished through an app that is running on the mobile device or through a web site if the mobile device is web-enabled. In an implementation in which the user accesses the social networking platform using a desktop computer, the user login can be accomplished through a web site that is running on the desktop computer.

In the example of FIG. 14, the method 1400 continues to block 1402 with displaying one or more connection requests to the user. The method 1400 can display at least a portion of a user profile of a requesting user (e.g., the user requesting the connection). For example, the method 1400 can display a user name, picture, age, and/or location. In an implementation, the one or more connection requests can be displayed as a list to the user (e.g., multiple connection requests are displayed simultaneously to the user). In another implementation, a connection request can be displayed individually to the user. The method 1400 continues to block 1403 with displaying additional information. In an implementation, the additional information can be profile information of the requesting user (e.g., interests, work experience, location, events, etc.).

In the example of FIG. 14, the method 1400 continues to decision point 1404 with determining whether the user accepts the connection request. If the user accepts the connection request, the method 1400 continues to block 1405 with adding the requesting user as a connection. In an implementation in which the user is a mentee, the requesting user is connected to the user as a mentor. In an implementation in which the user is a mentor, the requesting user is connected to the user as a mentee. If the user does not accept (e.g., rejects) the connection request, the method 1400 continues to decision point 1406 with determining whether the user saves the connection request. If the user does not save (e.g., rejects) the connection request, the method 1400 ends.

In the example of FIG. 14, if the user saves the connection request, the method 1400 continues to block 1407 with adding the saved connection request. In an implementation in which the user saves the connection request, the saved connected request is added to a saved request list. The method 1400 continues to decision block 1408 with determining whether the user indicates viewing the saved request. If the user indicates viewing the saved request, the method 1400 returns to block 1403. If the user does not indicate viewing the saved request, the method 1400 ends.

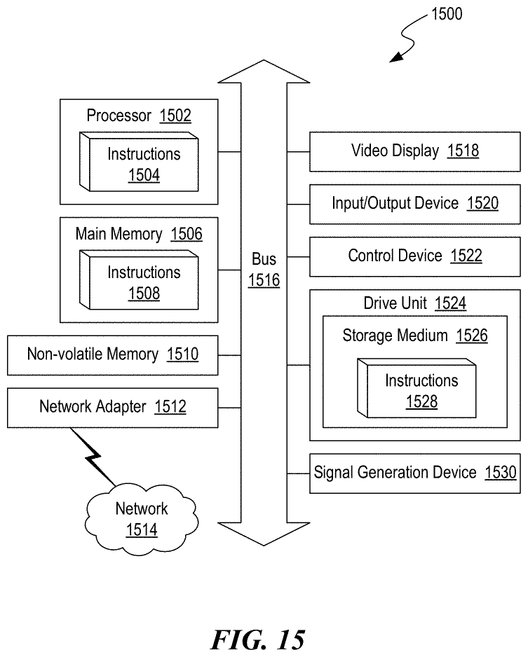

FIG. 15 is a block diagram illustrating an example of a processing system 1500 in which at least some operations described herein can be implemented. For example, one or more of the social networking platform 110 or database 120 may be implemented as the example processing system 1500. The processing system 1500 may include one or more central processing units (“processors”) 1502, main memory 1506, non-volatile memory 1510, network adapter 1512 (e.g., network interfaces), video display 1518, input/output devices 1520, control device 1522 (e.g., keyboard and pointing devices), drive unit 1524 including a storage medium 1526, and signal generation device 1530 that are communicatively connected to a bus 1516. The bus 1516 is illustrated as an abstraction that represents any one or more separate physical buses, point to point connections, or both connected by appropriate bridges, adapters, or controllers. The bus 1516, therefore, can include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 594 bus, also called “Firewire.”

In various embodiments, the processing system 1500 operates as part of a user device, although the processing system 1500 may also be connected (e.g., wired or wirelessly) to the user device. In a networked deployment, the processing system 1500 may operate in the capacity of a server or a client machine in a client-server network environment, or as a peer machine in a peer-to-peer (or distributed) network environment.

The processing system 1500 may be a server computer, a client computer, a personal computer, a tablet, a laptop computer, a personal digital assistant (PDA), a cellular phone, a processor, a web appliance, a network router, switch or bridge, a console, a hand-held console, a gaming device, a music player, network-connected (“smart”) televisions, television-connected devices, or any portable device or machine capable of executing a set of instructions (sequential or otherwise) that specify actions to be taken by the processing system 1500.

While the main memory 1506, non-volatile memory 1510, and storage medium 1526 (also called a “machine-readable medium) are shown to be a single medium, the term “machine-readable medium” and “storage medium” should be taken to include a single medium or multiple media (e.g., a centralized or distributed database, and/or associated caches and servers) that store one or more sets of instructions 1528. The term “machine-readable medium” and “storage medium” shall also be taken to include any medium that is capable of storing, encoding, or carrying a set of instructions for execution by the computing system and that cause the computing system to perform any one or more of the methodologies of the presently disclosed embodiments.

In general, the routines executed to implement the embodiments of the disclosure, may be implemented as part of an operating system or a specific application, component, program, object, module or sequence of instructions referred to as “computer programs.” The computer programs typically comprise one or more instructions (e.g., instructions 1504, 1508, 1528) set at various times in various memory and storage devices in a computer, and that, when read and executed by one or more processing units or processors 1502, cause the processing system 1500 to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution. For example, the technology described herein could be implemented using virtual machines or cloud computing services.

Further examples of machine-readable storage media, machine-readable media, or computer-readable (storage) media include, but are not limited to, recordable type media such as volatile and non-volatile memory devices 1510, floppy and other removable disks, hard disk drives, optical disks (e.g., Compact Disk Read-Only Memory (CD ROMS), Digital Versatile Disks (DVDs)), and transmission type media, such as digital and analog communication links.

The network adapter 1512 enables the processing system 1500 to mediate data in a network 1514 with an entity that is external to the processing system 1500 through any known and/or convenient communications protocol supported by the processing system 1500 and the external entity. The network adapter 1512 can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

The network adapter 1512 can include a firewall which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand.

As indicated above, the techniques introduced here implemented by, for example, programmable circuitry (e.g., one or more microprocessors), programmed with software and/or firmware, entirely in special-purpose hardwired (i.e., non-programmable) circuitry, or in a combination or such forms. Special-purpose circuitry can be in the form of, for example, one or more application-specific integrated circuits (ASICs), programmable logic devices (PLDs), field-programmable gate arrays (FPGAs), etc.

From the foregoing, it will be appreciated that specific embodiments of the invention have been described herein for purposes of illustration, but that various modifications may be made without deviating from the scope of the invention. Accordingly, the invention is not limited except as by the appended claims.

I/We claim:

1. A social matchmaking system, comprising a processor and a non-transitory computer readable storage medium storing executable computer program instructions that, when executed by the processor, cause the processor to perform a method comprising:
for one or more first users,
receiving a first indication from a first user to join a social match network,
communicating, by the processor, with a first GPS sensor in a mobile device associated with the first user to identify a first location, the first location including at least one of a first current location of the first user and a first previous location of the first user;
receiving a first information comprising first profile information that includes one or more first work experiences, the first information being sourced from the first user or a first third-party user profile on a social networking website,
receiving first match preferences from the first user,
creating a first profile associated with the first user based on the first information, and
populating a first directory with a first user identifier associated with the first user;
for one or more second users,
receiving a second indication from a second user to join the social match network,
communicating, by the processor, with a second GPS sensor in a mobile device associated with the second user to identify a second location, the second location including at least one of a second current location of the second user and a second previous location of the second user;
receiving a second information comprising second profile information that includes one or more second work experiences, the second information being sourced from the second user or a second third-party user profile on a social networking website,
creating a second profile associated with the second user based on the second information, and
populating a second directory with a second user identifier associated with the second user;
displaying the second directory to the first user;
generating a pre-qualifying list of second users, wherein the generation is based on the first location, first profile information and first match preferences of the first user, the second location and second profile information of the second user, and the one or more first work experiences and the one or more second work experiences having at least one substantially same work experience;
displaying the pre-qualifying list to the first user;
upon receiving an indication that the first user selects the second user from the second directory and/or from the pre-qualifying list, and
displaying the second page associated with the second user to the first user, upon receiving an indication that the first user requests a connection with the second user from the second directory and/or from the pre-qualifying list, notifying the second user from the directory and/or pre-qualifying list, and providing to the first user and the second user a mutual messaging platform;
for one or more first users and/or second users,
receiving event information, and
receiving one or more photos;
populating an event directory with the received event information;
displaying the event directory to the first user and/or the second user;
populating a photo directory with the received one or more photos; and
displaying the photo directory to the first user and/or the second user.

2. A method for facilitating matchmaking, comprising:
for one or more first users,
receiving, by a processor, a first indication from a first user to join a social match network,
communicating, by the processor, with a first GPS sensor in a mobile device associated with the first user to identify a first location;
receiving first profile information associated with the first user;
receiving first match preferences from the first user;
creating a first profile associated with the first user based on the first profile information, and
populating a first directory with a first user identifier associated with the first user;
for one or more second users,
receiving, by the processor, a second indication from a second user to join the social match network,
communicating, by the processor, with a second GPS sensor in a mobile device associated with the second user to identify a second location;
receiving second profile information associated with the second user;
creating a second profile associated with the second user based on the second profile information, and
populating a second directory with a second user identifier associated with the second user;
displaying the second directory to the first user;
generating a pre-qualifying list of second users, wherein the generation is based on the first location, first profile information and first match preferences of the first user and the second location and second profile information of the second user;
displaying the pre-qualifying list to the first user;
upon receiving an indication that the first user selects the second user from the second directory and/or from the pre-qualifying list,
displaying the second page associated with the second user to the first user; and
upon receiving an indication that the first user requests a connection with the second user from the second directory and/or from the pre-qualifying list, notifying the second user from the directory and/or pre-qualifying list, providing to the first user and the second user a mutual messaging platform.

3. The method of claim 2, wherein the first information is sourced from the first user or a first third-party user profile on a social networking website.

4. The method of claim 2, wherein the second information is sourced from the second user or a second third-party user profile on a social networking website.

5. The method of claim 2, wherein the first location includes a first current location of the first user, and the second location includes a second current location of the second user.

6. The method of claim 2, wherein the first location comprises a first previous location of the first user, and the second location comprises a second previous location of the second user.

7. The method of claim 2, wherein the first profile information comprises one or more first work experiences, and the second profile information comprises one or more second work experiences.

8. The method of claim 7, wherein the generation of the pre-qualifying list of second users is based on the one or more first work experiences and the one or more second work experiences.

9. The method of claim 8, wherein the generation of the pre-qualifying list of second user is based on the one or more first work experiences and the one or more second work experiences having at least one substantially same work experience.

10. The method of claim 2, further comprising:
receiving event information from the first user and/or the second user,
populating an event directory with the received event information, and
displaying the event directory to the first user and/or the second user.

11. The method of claim 2, further comprising:
receiving one or more photos from the first user and/or the second user,
populating a photo directory with the received one or more photos, and
displaying the photo directory to the first user and/or the second user.

12. The method of claim 2, wherein generating the pre-qualifying list of second users further comprises applying a trained machine learning model to at least one of the first profile associated with the first user or the second profile associated with the second user to identify a match between the first user and the second user.

13. The method of claim 12, further comprising recommending a purpose for the match between the first user and the second user based on at least one of the first profile associated with the first user or the second profile associated with the second user, wherein generating the pre-qualifying list of second users is further based on the recommended purpose.

14. The method of claim 2, further comprising:
determining an access level of the first user, wherein the access level includes a first access level, second access level, and/or third access level;
in the event that the first user belongs to the first access level, restricting access to the first user with a first set of access rights;
in the event that the first user belongs to the second access level, restricting access to the first user with a second set of access rights;
in the event that the first user belongs to the third access level, restricting access to the user with a third set of access rights, wherein the first set of access rights, second set of access rights and third set of access rights both include at least one of the following to:
view the user profile,
share photos or contact information,
participate in a matching program,
view a potential match generated based on match preferences,
accept or decline the potential match, or
send a first message to the potential match;

15. A method for facilitating mentorship matchmaking, comprising:
for one or more veterans,
receiving an indication from a veteran to join a mentorship network;
receiving information including at least one of a location received from a GPS sensor, background information, and mentorship preferences;
creating a veteran profile based on the received information;
determining an access level of the veteran, wherein the access level includes a first access level, second access level, and/or third access level;
in the event that the veteran belongs to the first access level, restricting access to the veteran with a first set of access rights;
in the event that the veteran belongs to the second access level, restricting access to the veteran with a second set of access rights;
in the event that the veteran belongs to the third access level, restricting access to the veteran with a third set of access rights, wherein the first set of access rights, second set of access rights and third set of access rights both include at least one of the following to:
view the veteran profile,
share photos or contact information,
participate in a mentorship program,
view a potential match generated based on mentorship preferences,
accept or decline the potential match, or
send a first message to the potential match; and
in the event that the veteran accepts the potential match, notifying the potential match.

16. The method of claim 15, wherein the first set of access rights, second set of access rights, and third set of access rights are different from each other.

17. The method of claim 15, wherein the first set of access rights and the second set of access rights includes participating in the mentorship program.

18. The method of claim 15, wherein the first set of access rights includes viewing at least a portion of the veteran profile of the veteran belonging to the second access level.

19. The method of claim 15, wherein the second set of access rights includes viewing at least a portion of the user profile of the veteran belonging to the first access level.

20. The method of claim 15, wherein the third set of access rights excludes participating in the mentorship program.
